(19) United States
(12) Patent Application Publication
(10) Pub. No.: US 2019/0043453 A1
(43) Pub. Date: Feb. 7, 2019

(54) ELECTRONIC DEVICE AND VIDEO DISPLAY METHOD

(71) Applicant: HON HAI PRECISION INDUSTRY CO., LTD., New Taipei (TW)

(72) Inventor: PO-CHUNG WANG, New Taipei (TW)

(21) Appl. No.: 15/785,499

(22) Filed: Oct. 17, 2017

(30) Foreign Application Priority Data
Aug. 3, 2017 (TW) 106126294

(51) Int. Cl. G09G 5/14; G09G 3/20; H04N 5/232; H04N 7/14; H04N 7/15

(52) U.S. Cl. CPC G09G 5/14; G09G 3/2092; H04N 5/23293; H04N 7/147; G09G 2340/0478; G09G 2320/10; G09G 2340/0442; G09G 2340/045; H04N 7/15

(57) ABSTRACT

An electronic device for displaying video signals on a display device has a processing device and a storage device. The processing device generates a user interface with an interface width. The user interface has a primary video region and a secondary video region including secondary video areas. The processing device determines a first region size of the primary video region and a second region size of the secondary video region based on a first aspect ratio and the interface width, and then determines an area height and an area width of the secondary video areas based on the second region size, a row quantity, and a second aspect ratio. The processing device determines whether a reference width generated based on the area width and the row quantity is longer than the interface width to set an area size of the secondary video areas for showing the video signals.

### CROSS-REFERENCE TO RELATED APPLICATIONS

This application claims priority to Taiwanese Patent Application No. 106126294 filed on Aug. 3, 2017, the contents of which are incorporated by reference herein.

### FIELD

The subject matter herein generally relates to a video interface and a video display method.

### BACKGROUND

User interface of most video conferencing systems cannot be adjusted. Thus, it is inconvenient for the users to see each of the meeting places in one videoconference when meeting members participate at many meeting places.

### BRIEF DESCRIPTION OF THE DRAWINGS

Implementations of the present technology will now be described, by way of example only, with reference to the attached figures.

FIG. 1 is a block diagram of one exemplary embodiment of an electronic device.

FIG. 2 is a block diagram of a second exemplary embodiment of function modules of a video display system in the electronic device of FIG. 1.

FIG. 3 illustrates a flowchart of a third exemplary embodiment of a video display method for the electronic device of FIG. 1.

FIG. 4A is a block diagram of a fourth exemplary embodiment of one user interface shown on the display device of the electronic device.

FIG. 4B is a block diagram of a fifth exemplary embodiment of another user interface shown on the display device of the electronic device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts can be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series, and the like.

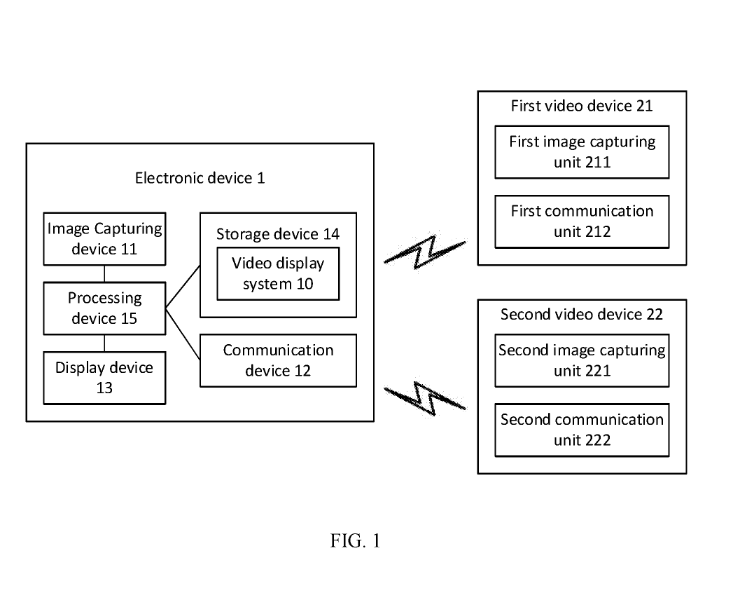

FIG. 1 illustrates an exemplary embodiment of an electronic device 1 coupled to at least one video device. In the embodiment, the electronic device 1 is coupled to two video devices 21 and 22, and electronic device 1 can include an image capturing device 11, a communication device 12, a display device 13, a storage device 14, and a processing device 15. The image capturing device 11, the communication device 12, the display device 13, and the storage device 14 are coupled to the processing device 15 via a system bus (not shown).

In at least one embodiment, the first video device 21 includes a first image capturing unit 211 and a first communication unit 212, and the second video device 22 includes a second image capturing unit 221 and a second communication unit 222. The image capturing units 211 and 221 can capture real-time images to form video signals, and the communication units 212 and 222 can communicate with the communication device 12 to transmit the video signals to the electronic device 1.

In at least one embodiment, the electronic device 1 and the video devices 21 and 22 can be a mobile phone, a tablet, a desktop, a notebook, or other electronic device. FIG. 1 illustrates only one example of an electronic device 1, and the electronic device 1 in other embodiments can include more or less components than as illustrated, or have a different configuration of the various components. In addition, FIG. 1 also illustrates only one example of video devices 21 and 22, the video devices 21 and 22 in other embodiments can include more or less components than as illustrated, or have a different configuration of the various components. In at least one embodiment, components in the first video device 21 can be different from those in the second video device 22.

In at least one embodiment, the image capturing device 11, the first image capturing unit 211, and the second image capturing unit 221 can be a charge-coupled device (CCD) image sensor, a complementary metal-oxide-semiconductor (CMOS) image sensor, or a camera. In the embodiment, the image capturing device 11 can be internally coupled to the processing device 15 of the electronic device 1. In at least one embodiment, the image capturing device 11 can have a third communication unit (not shown) externally coupled to the electronic device 1 to provide a video signal to the electronic device 1 via the communication device 12. In at least one embodiment, the third communication unit of the image capturing device 15 can directly communicate with the first communication unit 212 and the second communication unit 222 to receive the video signals from the first video device 21 and the second video device 22.

In at least one embodiment, the communication device 12, the first communication unit 212, and the second communication unit 222 can adopt customizable protocols or follow existing standards or de facto standards such as BLUETOOTH, ETHERNET, IEEE 802.11 and IEEE 802.15 series, Wireless USB, infrared communication or telecommunication standards such as GSM, CDMA2000, TD-SCDMA, WiMAX, 3GPP-LTE, and TD-LTE.

In at least one embodiment, the display device 13 can include a display using liquid crystal display (LCD) technology, an organic light emitting diode (OLED) display technology, or light emitting polymer display (LPD) technology, although other display technologies can be used in other embodiments. In addition, the display device 13 can show input information when users input the input information via an input device (not shown). In at least one embodiment, the display device 13 can be integrated with a touch detecting unit to form a touch screen, such as an LCD touch screen or an OLED touch screen, for detecting at least one touch on the display device 13. The touch detecting unit can be a resistive touch sensor, a capacitive touch sensor, or other forms of electronic or optical sensor to determine coordinates of the touch.

In at least one embodiment, the storage device 14 can be a non-volatile computer readable storage medium that can be electrically erased and reprogrammed, such as read-only memory (ROM), random-access memory (RAM), erasable programmable ROM (EPROM), electrically EPROM (EEPROM), hard disk, solid state drive, or other forms of electronic, electromagnetic, or optical recording medium. In at least one embodiment, the storage device 14 can include interfaces that can enable access to the aforementioned computer readable storage medium, to enable the electronic device 1 to connect to and access such computer readable storage medium. In another embodiment, the storage device 14 can include a network accessing device to enable the electronic device 1 to connect and access data stored in a remote server or a network-attached storage.

In at least one embodiment, the processing device 15 can be a processor, a central processing unit (CPU), a graphic processing unit (GPU), a system on chip (SoC), a field-programmable gate array (FPGA), or a controller for executing the program instruction in the storage device 14. The processing device 15 can further include an embedded system or an application specific integrated circuit (ASIC) having embedded program instructions.

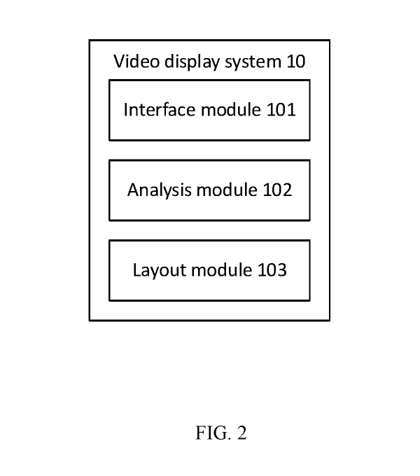

FIG. 2 illustrates a second exemplary embodiment of function modules of the video display system 10 in the electronic device 1 of FIG. 1. In at least one embodiment, the video display system 10 can include one or more modules, for example, an interface module 101, an analysis module 102, and a layout module 103. “Module,” as used herein, refers to logic embodied in hardware or firmware, or to a collection of software instructions, written in a programming language, such as, JAVA, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives.

In at least one embodiment, the interface module 101 generates a user interface including a primary video region and a secondary video region for showing a plurality of video signals in the user interface on the display device 13. In at least one embodiment, the analysis module 102 analyzes a plurality of parameters, such as an interface size, a predefined aspect ratio, and number of the video signals, to determine region sizes of the primary video region and the secondary video region. In at least one embodiment, the layout module 103 arranges a layout of the user interface based on the region sizes and shows the video signals in the primary video region and the secondary video region on the display device 13.

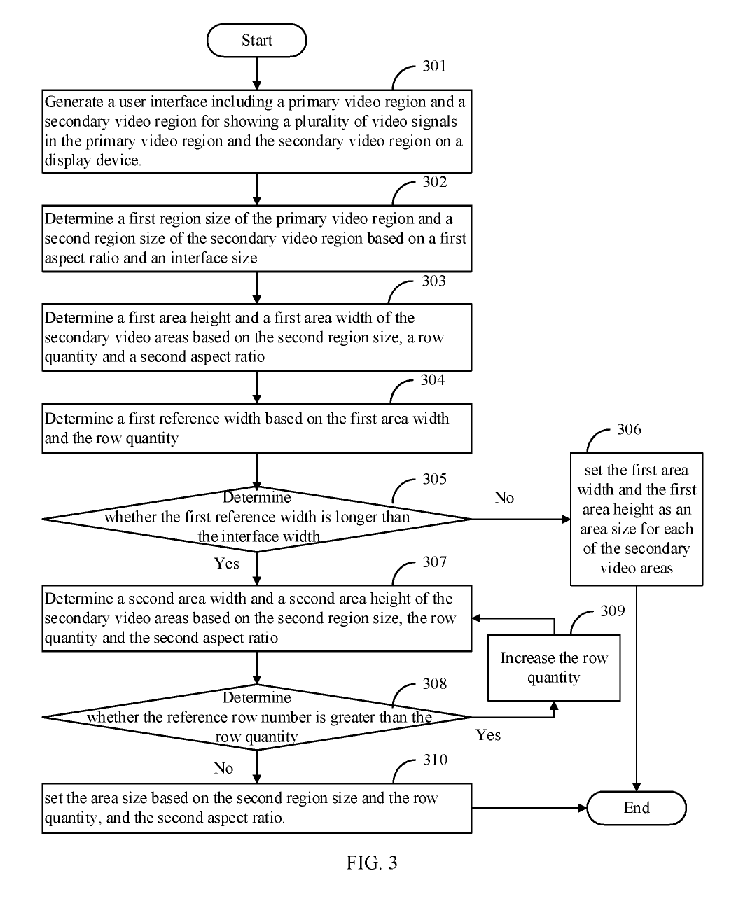

FIG. 3 illustrates a flowchart in accordance with a third exemplary embodiment. The example method is provided by way of example, as there are a variety of ways to carry out the method. The method described below can be carried out using the configuration illustrated in FIG. 1, for example, and various elements of these figures are referenced in explaining the example method. Each block shown in FIG. 3 represents one or more processes, methods, or subroutines, carried out in the example method. Furthermore, the order of blocks is illustrative only and can change. Additional blocks can be added or less blocks can be utilized without departing from this disclosure. The example method can begin at block 301.

At block 301, the interface module 101 generates a user interface including a primary video region and a secondary video region for showing a plurality of video signals in the primary video region and the secondary video region on the display device 13.

In at least one embodiment, the communication device 12 is coupled to at least one video device. The number of the at least one video device is N. The electronic device 1 can show X video signals generated by X signal sources selected from the N video devices and the image capturing device 11 on the display device 13. In a first embodiment, each of the N video devices provides a video signal to the communication device 12, and the electronic device 1 shows the N video signals received from the N video devices on the display device 13. In the first embodiment, X is equal to N. In a second embodiment, a specific one of the N video devices provides two video signals, each of the other N video devices provides one video signal, and the electronic device 1 shows the N+1 video signals received from the N video devices on the display device 13. In the second embodiment, X is equal to N+1. In the second embodiment, the specific video device can provide a first video signal generated from an image capturing unit of the specific video device and a second video signal showing a screen image shared from the specific video device. In a third embodiment, the image capturing device 11 provides a video signal, each of the N video devices provide a video signal, and the electronic device 1 shows the N+1 video signals of the image capturing device 11 and the N video devices on the display device 13. In the third embodiment, X is equal to N+1. In a fourth embodiment, the electronic device 1 shows the N video signals selected from the N video signals of the N video devices and the video signal of the image capturing device 11 on the display device 13. In the fourth embodiment, X is equal to N.

In at least one embodiment, the interface module 101 can generate X video areas based on the number of the video signals to be shown on the display device 13. In one embodiment, the interface module 101 can generate X video areas for X video signals. The interface module 101 sets a specific one of the X video areas as a primary video area in the primary video region for a specific one of the X video signals, and sets the other video areas as X−1 secondary video areas in the secondary video region for the other video signals.

In at least one embodiment, the processing device 15 can automatically set the specific video signal as a primary video signal, and set the other video signals as a plurality of secondary video signals. In the embodiment, the processing device 15 can show the primary video signal in the primary video area of the primary video region, and show the secondary video signals in the secondary video areas of the secondary video region. For example, the primary video signal can be shown in the primary video area, and the X−1 secondary video signals can be shown in the X−1 secondary video areas. In at least one embodiment, the processing device 15 can select a specific one of the video signals to be the primary video signal based on a user's input.

For example, there is a video conference between six meeting places including a local conference room and five remote conference rooms. In one embodiment, the electronic device 1 is installed in the local conference room, and five video devices are respectively installed in the five remote conference rooms. A video signal captured by the image capturing device 11 of the electronic device 1 can be set as the primary video signal by the user's input or automatically by the processing device 15, and the five video signals captured by the five video devices can be set as the secondary video signals. Thus, the video signal captured by the image capturing device 11 can be shown in the primary video region, and the video signals captured by the five video devices can be shown in the secondary video areas. In the embodiment, each of the electronic device 1 and the five video devices can include a display device showing the primary video signal in the primary video region and the secondary video signals in the secondary video areas.

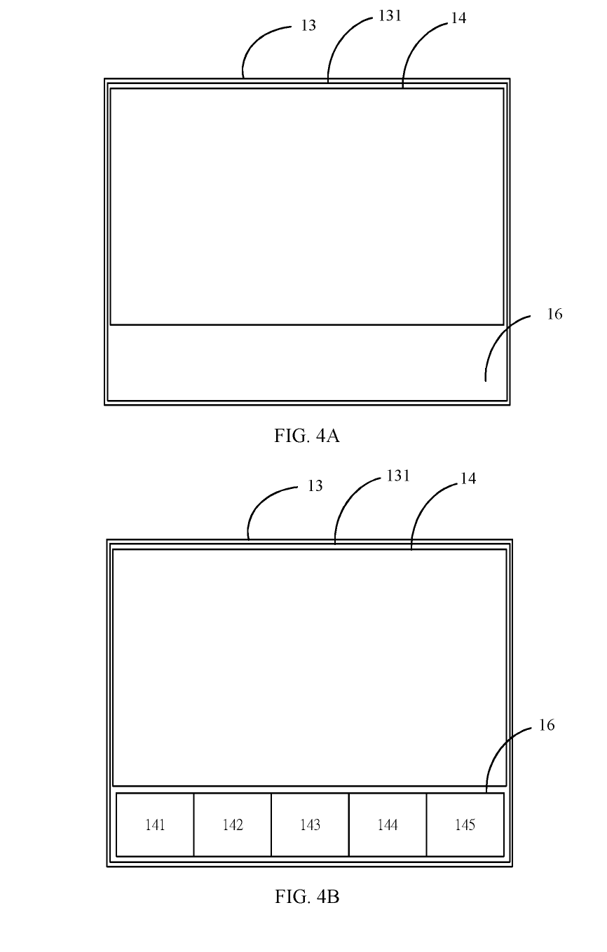

FIG. 4A is a block diagram of a fourth exemplary embodiment of one user interface 131 shown on the display device 13 of the electronic device 1. The processing device 15 can show the user interface 131 on the display device 13. The user interface 131 can include the primary video region 14 for showing the primary video signal and a remaining video region 16 being the secondary video region 16 for showing the secondary video signals.

In at least one embodiment, the interface module 101 can generate the user interface 131 based on size of the display device 13. Thus, an interface size of the user interface 131 can be identical to a display region size of the display device 13. The interface size includes an interface width and an interface height, and the display region size includes a display region width and a display region height. In at least one embodiment, the interface width can be identical to the display region width and the interface height can be identical to the display region height.

In at least one embodiment, the secondary video region can include a plurality of secondary video areas arranged in at least one row. For example, there can be five secondary video areas arranged in two rows to show five secondary video signals on the display device 13.

At block 302, the analysis module 102 determines a first region size of the primary video region based on a first aspect ratio and the interface size, and determines a second region size of the secondary video region based on difference between the interface size and the first region size. In the embodiment, the first region size can include a first region width and a first region height, and the second region size can include a second region width and a second region height. In the embodiment, the first aspect ratio is predefined for the primary video region.

In at least one embodiment, the analysis module 102 can determine the first region size based on the first aspect ratio and the interface width. In one embodiment, the first region width can be identical to the interface width. For example, the interface width is 100 cm, the interface height is 80 cm, and the first aspect ratio is 2:1. Thus, the analysis module 102 determines the first region width as 100 cm based on the interface width, and determines the first region height should be 50 cm, based on the first region width and the first aspect ratio.

In at least one embodiment, the analysis module 102 can determine the second region size of the secondary video region based on difference between the interface size and the first region size. For example, the interface width and the first region width are 100 cm, the interface height is 80 cm, and the first region height is 50 cm. Thus, the analysis module 102 determines the second region width as 100 cm based on the interface width, and determines the second region height as 30 cm based on the interface height and the first region height.

In at least one embodiment, the interface size of the user interface 131 in FIG. 4A is slightly smaller than the display region size, and the first region width of the primary video region 14 in FIG. 4A is slightly shorter than the interface width of the user interface 131. In at least one embodiment, the interface size of the user interface 131 can be identical to the display region size, and the first region width of the primary video region 14 can be identical to the interface width of the user interface 131. In at least one embodiment, the primary video region 14 and the secondary video region 16 can be horizontally centered, and the primary video region 14 can be aligned along the top of the user interface 131.

At block 303, the analysis module 102 determines a first area height for the secondary video areas based on the second region size and a row quantity, and determines a first area width for the secondary video areas based on the first area height and a second aspect ratio of the secondary video areas. In the embodiment, the number of the at least one rows can be set as the row quantity, and the second aspect ratio is predefined for the secondary video areas.

In at least one embodiment, the analysis module 102 determines the first area height for the secondary video areas based on the second region height and the row quantity. If the second region height is 30 cm and the row quantity is 1, the analysis module 102 can set the first area height as 30 cm. If the second region height is 30 cm and the row quantity is 2, the analysis module 102 can set the first area height as 15 cm.

In at least one embodiment, the analysis module 102 determines the first area width based on the first area height and the second aspect ratio. For example, if the first area height is 30 cm and the second aspect ratio is 2:1, the analysis module 102 can determine the first area width as 60 cm.

In at least one embodiment, the analysis module 102 can directly set the row quantity to be one when the row quantity is not pre-defined. Thus, the secondary video areas can be arranged in one row in the secondary video region. In one embodiment, the analysis module 102 can further show a setting interface (not shown) for users to set the first aspect ratio, the second aspect ratio, and the row quantity. Thus, the analysis module 102 can receive the users' input to set the first aspect ratio, the second aspect ratio, and the row quantity.

At block 304, the analysis module 102 determines a first reference width based on the first area width and the row quantity.

In at least one embodiment, the analysis module 102 determines average number of the secondary video areas per row, and then determines the first reference width based on the first area width and the average number. For example, the number of the video signal is six and the row quantity is one. Then, the interface module 101 can generate five secondary video areas, and the analysis module 102 determines the average number as five. Thus, the analysis module 102 can determine the first reference width by multiplying the first area width by five. In another embodiment, the number of the video signals is six and the row quantity is two. Then, the interface module 101 can generate five secondary video areas, and the analysis module 102 determines the average number as 2.5. In this embodiment, the analysis module 102 can further generate a first reference area number being equal to three since the average number is not an integer. The first reference area number is a smallest integer that is not less than the average number. Then, the analysis module 102 can determine the first reference width by multiplying the first area width by the first reference number equal to three.

At block 305, the analysis module 102 determines whether the first reference width is longer than the interface width to set an area size of the secondary video areas for showing the video signals in the user interface on the display device 13 based on the comparison between the first reference width and the interface width. If the first reference width is shorter than or identical to the interface width, the procedure goes to block 306. If the first reference width is longer than the interface width, the procedure goes to block 307.

For example, the number of the video signals is six, and the interface width is 100 cm. In one embodiment, the analysis module 102 can determine the first reference width as 300 cm longer than the interface width when the row quantity is determined as one and the first area width is determined as 60 cm. In one embodiment, the analysis module 102 can determine the first reference width as 90 cm shorter than the interface width when the row quantity is determined as two and the first area width is determined as 30 cm.

At block 306, the layout module 103 sets the first area width and the first area height as the area size for each of the secondary video areas to show the video signals in the user interface on the display device 13.

In at least one embodiment, the layout module 103 arranges the user interface based on the first region size of the primary video region, the area size of the secondary video areas, and the row quantity. FIG. 4B is a block diagram of a fifth exemplary embodiment of another user interface shown on the display device 13 of the electronic device 1. The layout module 103 arranges the secondary video region 16 to set five secondary video areas 141-145 arranged in one row.

At block 307, the analysis module 102 determines a second area width for the secondary video areas based on the second region size and the row quantity, and determines a second area height for the secondary video areas based on the second area width and the second aspect ratio.

In at least one embodiment, the analysis module 102 determines the first reference area number based on the average number of the secondary video areas per row, and then determines the second area width by dividing the second region width by the first reference area number. The analysis module 102 further determines the second area height based on the second area width and the second aspect ratio.

For example, the number of the video signals is six, the row quantity is one, and the second region width is 100 cm. The interface module 101 generates five secondary video areas, and the analysis module 102 determines the first reference area number as five. Thus, the analysis module 102 can determine the second area width as 20 cm by dividing the second region width by five. The analysis module 102 can further determine the second area height as 10 cm based on the second aspect ratio. In another embodiment, the row quantity is set as two. The interface module 101 generates five secondary video areas. The analysis module 102 determines the average number as 2.5 and the first reference area number as three, and determines the second area width as 33.33 cm by dividing the second region width by three. Thus, the analysis module 102 can further determine the second area height as 16.67 cm based on the second aspect ratio.

At block 308, the analysis module 102 determines whether a reference row number is greater than the row quantity to set the area size for showing the video signals in the user interface on the display device 13. If the reference row number is greater than the row quantity, the procedure goes to block 309. If the reference row number is less than or equal to the row quantity, the procedure goes to block 310.

In at least one embodiment, the analysis module 102 determines a second reference area number by dividing the second region height by the second area height, and then determines the reference row number based on the second reference area number. The reference row number is a largest integer that is not greater than the second reference area number.

In one embodiment, the analysis module 102 can determine that the second region height of the secondary video region is long enough for the layout module 103 to add one row in the secondary video region, if the reference row number is greater than the row quantity. Thus, the analysis module 102 can increase the row quantity. For example, the second region width is 100 cm, the second region height is 30 cm, the number of the secondary video areas is five, and the row quantity is one. The analysis module 102 determines the second area width as 20 cm based on the second region width and the row quantity, and determines the second area height as 10 cm based on the second area width and the second aspect ratio. The analysis module 102 further determines the second reference area number and the reference row number as three based on the second region height and the second area height. Thus, the reference row number is greater than the row quantity, and the row quantity can be increased.

In one embodiment, the analysis module 102 determines that the row quantity cannot be increased, if the reference row number is less than or equal to the row quantity. For example, the second region width is 100 cm, the second region height is 30 cm, the number of the secondary video areas is five, and the row quantity is two. The analysis module 102 determines the second area width as 33.33 cm based on the second region width and the row quantity, and determines the second area height as 16.67 cm based on the second area width and the second aspect ratio. The analysis module 102 further determines the second reference area number as 1.8, and determines the reference row number as one based on the second region height and the second area height. Thus, the reference row number is less than the row quantity, and the row quantity cannot be increased.

At block 309, the analysis module 102 increases the row quantity to generate at least two rows for the secondary video areas when the reference row number is greater than the row quantity. In the embodiment, the number of the at least two rows can be regarded an increased row quantity. Then, the procedure goes back to block 306.

In at least one embodiment, the interface module 101 generates the user interface 131 again based on the first region size of the primary video region, the area size of the secondary video areas, and the increased row quantity. Then, the analysis modules 102 can determine the second area width and the second area height again based on the increased row quantity.

At block 310, the layout module 103 sets the area size for showing the video signals in the user interface on the display device 13 when the reference row number is less than or equal to the row quantity.

In at least one embodiment, the layout module 103 determines a third area height for the secondary video areas based on the second region size and the row quantity. The layout module 103 determines a third area width for the secondary video areas based on the third area height and the second aspect ratio. Then, the layout module 103 sets the third area height and the third area width as the area size for showing the video signals in the user interface on the display device 13. Thus, the layout module 103 arranges the user interface 131 based on the first region size of the primary video region, the third area width and the third area height of the secondary video areas, and the row quantity.

In at least one embodiment, the layout module 103 can arrange the secondary video areas based on the arrangement of the primary video region. For example, the secondary video areas in each of the at least one rows can be horizontally centered. If the row quantity is equal to one, the secondary video areas can be aligned along the bottom of the primary video region, aligned along the bottom of the user interface, or vertically centered in the secondary video region. If the row quantity is greater than one, the layout module 103 can arrange the secondary video areas from left to right and from up to down to generate a secondary video section. Then, the secondary video section can be aligned along the bottom of the primary video region, aligned along the bottom of the user interface, or vertically centered in the secondary video region.

In at least one embodiment, the interface module 101 rechecks the interface size when the interface size is changed by users. Then, the analysis module 102 can determine a new first region size and a new area size based on the adjusted interface size at blocks 302 to 310.

In at least one embodiment, the interface module 101 generates a new secondary video area for a new video signal and increases the number of the secondary video areas, if a new video device provides the new video signal for showing in the display device 13. Then, the analysis module 102 can determine a new area size based on the increased number at blocks 303 to 310.

In at least one embodiment, the interface module 101 erases one of the secondary video areas and decreases the number of the secondary video areas, if the electronic device 1 does not receive one of the video signals. Then, the analysis module 102 can determine a new area size based on the decreased number at blocks 303 to 310. In addition, the analysis module 102 also determines a new area size based on the decreased number at blocks 303 to 310 when the electronic device 1 receives an input to stop showing one of the received video signals on the display device 13.

The embodiments shown and described above are only examples. Even though numerous characteristics and advantages of the present technology have been set forth in the foregoing description, together with details of the structure and function of the present disclosure, the disclosure is illustrative only, and changes can be made in the detail, including in matters of shape, size, and arrangement of the parts within the principles of the present disclosure, up to and including the full extent established by the broad general meaning of the terms used in the claims.

1. An electronic device, comprising:
a processing device; and
a storage device coupled to the processing device and storing a plurality of instructions which, when executed by the processing device, cause the processing device to:
generate a user interface including a primary video region and a secondary video region for showing a plurality of video signals in the primary video region and the secondary video region on a display device coupled to the electronic device, wherein the user interface has an interface size including an interface width, and a plurality of secondary video areas are arranged in at least one row in the secondary video region;
determine a first region size of the primary video region based on a first aspect ratio and the interface size, and determine a remaining region size in the user interface as a second region size of the secondary video region;
determine a first area height for the secondary video areas based on the second region size and a row quantity, and determine a first area width for the secondary video areas by multiplying the first area height by a second aspect ratio;
determine an average number of the secondary video areas per row;
determine a first reference width based on the first area width and the average number of the secondary video areas per row;
determine whether the first reference width is longer than the interface width, and
set an area size of the secondary video areas for showing the video signals in the primary video region and the secondary video areas on the display device based on the determination whether the first reference width is longer than the interface width.

2. The electronic device according to claim 1, further comprising instructions to:
set the first area width and the first area height as the area size for each of the secondary video regions when the first reference width is shorter than or identical to the interface width; and
show one of the video signals in the primary video region having the first region size and the other video signals in the secondary video areas having the area size on the display device.

3. The electronic device according to claim 1, further comprising instructions to:
determine a second area width for the secondary video areas based on the second region size and the row quantity, and determine a second area height for the secondary video areas by multiplying the second area width by the second aspect ratio when the first reference width is longer than the interface width;
determine whether a reference row number is greater than the row quantity, wherein the reference row number is generated based on the second area height and a second region height of the second region size; and
set the area size for showing the video signals in the primary video region and the secondary video areas on the display device based on the determination whether the reference row number is greater than the row quantity.

4. The electronic device according to claim 3, further comprising instructions to:
increase the row quantity to generate at least two rows for the secondary video areas when the reference row number is greater than the row quantity; and
set the area size for showing the video signals in the primary video region and the secondary video areas on the display device when the reference row number is less than or equal to the row quantity.

5. The electronic device according to claim 4, further comprising instructions to:
determine a third area height for the secondary video areas based on the second region size and the row quantity;
determine a third area width for the secondary video areas by multiplying the third area height by the second aspect ratio;
set the third area height and the third area width as the area size; and
show one of the video signals in the primary video region having the first region size and the other video signals in the secondary video areas having the area size on the display device.

6. The electronic device according to claim 1, further comprising:
a communication device coupled to at least one video device, each of at least one video device has an image capturing unit and a communication unit to provide one of the video signals to the communication device.

7. The electronic device according to claim 1, further comprising instructions to:
set one of the video signals as a primary video to show in the primary video region having the first region size on the display device; and
set the remaining video signals as a plurality of secondary videos, each of the secondary videos shows in one of the secondary video areas having the area size on the display device.

8. A video display method for an electronic device to display a plurality of video signals on a display device coupled to the electronic device, the method comprising:
generating a user interface including a primary video region and a secondary video region for showing the plurality of video signals in the user interface on the display device, wherein the user interface has an interface size including an interface width, and the secondary video region includes a plurality of secondary video areas arranged in at least one row;
determining a first region size of the primary video region based on a first aspect ratio and the interface size, and determining a second region size of the secondary video region based on difference between the interface size and the first region size;
determining a first area height and a first area width for the secondary video areas based on the second region size, a row quantity and a second aspect ratio;
determining an average number of the secondary video areas per row;
determining a first reference width based on the first area width and the average number; and
determining whether the first reference width is longer than the interface width; and
setting an area size of the secondary video areas for showing the video signals in the primary video region and the secondary video areas on the display device based on determination whether the first reference width is longer than the interface width.

9. The method according to claim 8, comprising:
determining the first area height for the secondary video areas based on the second region size and the row quantity; and
determining the first area width for the secondary video areas by multiplying the first area height by the second aspect ratio.

10. The method according to claim 8, comprising:
setting the first area width and the first area height as the area size for each of the secondary video regions when the first reference width is shorter than or identical to the interface width; and
showing one of the video signals in the primary video region having the first region size and the other video signals in the secondary video areas having the area size on the display device.

11. The method according to claim 8, comprising:
determining a second area width for the secondary video areas based on the second region size and the row quantity, and determining a second area height for the secondary video areas by multiplying the second area width by the second aspect ratio when the first reference width is longer than the interface width;
determining whether a reference row number is greater than the row quantity, wherein the reference row number is generated based on the second area height and a second region height of the second region size; and
setting the area size for showing the video signals in the primary video region and the secondary video areas on the display device based on the determination whether the reference row number is greater than the row quantity.

12. The method according to claim 11, comprising:
increasing the row quantity to generate at least two rows for the secondary video areas when the reference row number is greater than the row quantity; and
setting the area size for showing the video signals in the primary video region and the secondary video areas on the display device when the reference row number is less than or equal to the row quantity.

13. The method according to claim 8, wherein the electronic device includes a communication device coupled to at least one video device, each of at least one video device has an image capturing unit and a communication unit to provide one of the video signals to the communication device.

14. The method according to claim 8, comprising:
setting one of the video signals as a primary video to show in the primary video region having the first region size on the display device; and
setting the remaining video signals as a plurality of secondary videos, each of the secondary videos shows in one of the secondary video areas having the area size on the display device.
